(19) United States
(12) Patent Application Publication
(10) Pub. No.: US 2005/0254098 A1
(43) Pub. Date: Nov. 17, 2005

(54) Image transmission system capable of registering information for creation of one-touch buttons

(75) Inventor: Hideyuki Matsuda, Suita-Shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Konica Minolta Business Technologies, Inc., Tokyo (JP)

(21) Appl. No.: 11/000,390

(22) Filed: Dec. 1, 2004

(30) Foreign Application Priority Data
May 12, 2004 (JP) 2004-142643

(51) Int. Cl. H04N 1/00

(52) U.S. Cl. 358/402; 358/440; 358/407

(57) ABSTRACT

An image transmission system capable of reducing the amount of labor required of the user during registration of one-touch information. The image transmission system comprises an image transmission apparatus and a relay apparatus that sends image data received from such image transmission apparatus to a prescribed recipient. Such relay apparatus includes a receiving unit that receives from the image transmission apparatus image data and setting information for the transmission thereof, a specifying unit that specifies the user who sent the image data, a storage unit that stores and associates the specified user and the setting information, a transmission unit that sends the received image data to a prescribed recipient in accordance with the setting information, and an output unit that, when accessed by the user, outputs the setting information stored in the storage unit and corresponding to such user as information for creation of one-touch buttons. Such image transmission apparatus includes a transmission unit that sends the image data and the setting information to the relay apparatus, a receiving unit that receives the information for creation of one-touch buttons that was output from the relay apparatus, and a display unit that creates one-touch buttons based on the information for creation of one-touch buttons and displays them.

This application is based on Japanese Patent Application No. 2004-142643 filed in Japan on May 12, 2004, the entire content of which is hereby incorporated by reference.

### BACKGROUND OF THE INVENTION

1. Field of the Invention

The present invention relates to an image transmission system, and more particularly to an image transmission system that can easily register information for creation of a one-touch button as well as to an image transmission apparatus and relay apparatus included in such system.

2. Description of Related Art

Apparatuses that include a scanner that reads an original document, such as MFPs (Multifunction Peripherals), are known in the conventional art, and electronic data obtained though scanning using an MFP or other apparatus can be sent to others.

When a user operates the operation panel of an MFP or similar apparatus to send image data to a desired recipient, a one-touch button is often used. One-touch buttons are buttons displayed on the liquid crystal display of the operation panel (or buttons comprising mechanical switches), and by pressing a one-touch button, transmission is made to the recipient corresponding to that one-touch button using parameter values corresponding to that one-touch button (such as scan mode or transmission mode).

The use of a one-touch button reduces the amount of effort needed by the user to input the setting information.

The prior art includes Japanese Patent Laid-Open No. 2003-30108, which discloses a technology that, in connection with a facsimile machine that sends and receives images, extracts and automatically registers the e-mail address from a received image e-mail.

Japanese Patent Laid-Open No. 2000-307782 discloses a scanner that registers scanning parameter values in association with a user ID input into the scanner main unit.

Japanese Patent Laid-Open No. 2001-148753 discloses a network scanner for which the scan parameter values are reserved therein in advance from the host computer. According to this technology, when an IC card is inserted in the scanner, personal authentication is carried out based thereon, a list of scan parameter values reserved in advance is loaded, and user selection of parameter values is accepted from among this list.

Japanese Patent Laid-Open No. 2003-87479 discloses a technology for a scan server to record scanning information including the user ID and scanning parameter values and send the scanning information corresponding to the user ID to the scanner. The scanner displays the received scanning information on the operation display to enable the user to change them.

However, because information such as the recipient and transmission parameter values (one-touch information) must be registered in association with a one-touch button, the user is required carry out a registration operation.

### OBJECT AND SUMMARY

An object of the present invention is to provide an improved image transmission system that resolves the various problems identified above.

Another object of the present invention is to provide an image transmission system that can reduce the amount of labor required of the user during registration of one-touch information.

These objects can be attained by providing an image transmission system comprising an image transmission apparatus and a relay apparatus that sends image data received from such image transmission apparatus to a prescribed recipient, wherein
such relay apparatus including:
   a receiving unit that receives from the image transmission apparatus image data and setting information for the transmission thereof;
   a specifying unit that specifies the user who sent the image data;
   a storage unit that stores and associates the specified user and the setting information;
   a transmission unit that sends the received image data to a prescribed recipient in accordance with the setting information; and
   an output unit that, when accessed by the user, outputs the setting information stored in the storage unit and corresponding to such user as information for creation of one-touch buttons, and
such image transmission apparatus including:
   a transmission unit that sends the image data and the setting information to the relay apparatus;
   a receiving unit that receives the information for creation of one-touch buttons that was output from the relay apparatus; and
   a display unit that creates one-touch buttons based on the information for creation of one-touch buttons and displays them.

### BRIEF DESCRIPTION OF THE DRAWINGS

These and other objects and features of the present invention will become clear from the following description taken in conjunction with the preferred embodiments thereof with reference to the accompanying drawings, in which:

FIG. 1 is a block diagram showing the construction of an image transmission system comprising one embodiment of the present invention, which includes a relay apparatus and image transmission apparatuses;

FIG. 2 is a block diagram showing the construction of one of the MFPs 100a, 100b shown in FIG. 1;

FIG. 3 is a block diagram showing the construction of either of the PCs 300a, 300b or the server 400 shown in FIG. 1;

FIG. 4 explains the processing carried out by the MFP 100, server 400 and PC 300a;

FIG. 5 is a flow chart showing the processing carried out by the server 400;

FIG. 6 shows a specific example of one-touch buttons displayed on the operation panel 127 of the MFP;

FIG. 7 shows a specific example of a one-touch registration management table; and

FIG. 8 is a flow chart showing the processing carried out by the MFP 100.

### DETAILED DESCRIPTION OF THE PREFERRED EMBODIMENTS

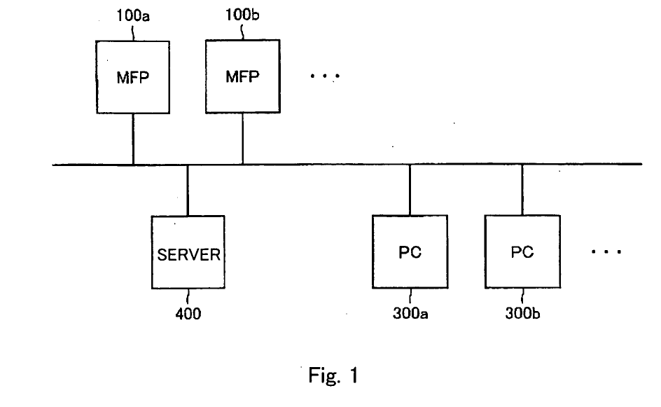

FIG. 1 is a block diagram showing the construction of an image transmission system comprising one embodiment of the present invention, which includes a relay apparatus and image transmission apparatuses.

With reference to the drawing, the image transmission system comprises MFPs 100a, 100b, which serve as image transmission apparatuses, user PCs 300a, 300b, and a server 400 serving as a relay apparatus, all of which are connected to a network.

Where image data read by the MFP 100a (or 100b) is to be sent to the external PC 300a (or 300b) via the server 400, the MFP 100a sends the setting entered by the MFP user to the server 400 as well. Where a session is underway between the MFP 100a and the server 400 for one user account and the received setting is not saved in the server 400 as a setting for that user, the server 400 saves the received setting as setting (one-touch information) for that user.

For example, an e-mail or a dedicated software program may be used to transmit an image from the MFP 100a. Where transmission is made using an e-mail, the server 400 serves as a mail server.

Where a session is underway between the MFP 100a and the server 400 using a public account (i.e., an account that can be used by any user, who need not be a specified user) or where no session is underway, the server 400 specifies the user who sent the image from the ‘From:’ address of the received e-mail or the like, and saves this information as a setting (one-touch information) for that user.

The setting thus saved is sent from the server 400 to the MFP 100a or 100b next time onward when a session is held between the MFP 100a or 100b and the server 400. The MFP 100a or 100b creates and displays one-touch buttons on its liquid crystal display or the like based on the received setting (one-touch information). The user can easily execute transmission without entering any setting information by using these one-touch buttons.

According to this embodiment, because one-touch information is automatically registered based on communication between the MFP and the server as described above, it is no longer necessary for the user to register one-touch information using a dedicated registration operation. In addition, because one-touch information is registered on the server, one-touch information can be shared among multiple MFPs. In other words, one-touch information registered using the MFP 100a can be used on the MFP 100b as well.

Furthermore, because one-touch information is recorded on the server, there is less of a limitation on the number of registrations that can be made in comparison with the situation in which one-touch information is recorded on a device such as an MFP.

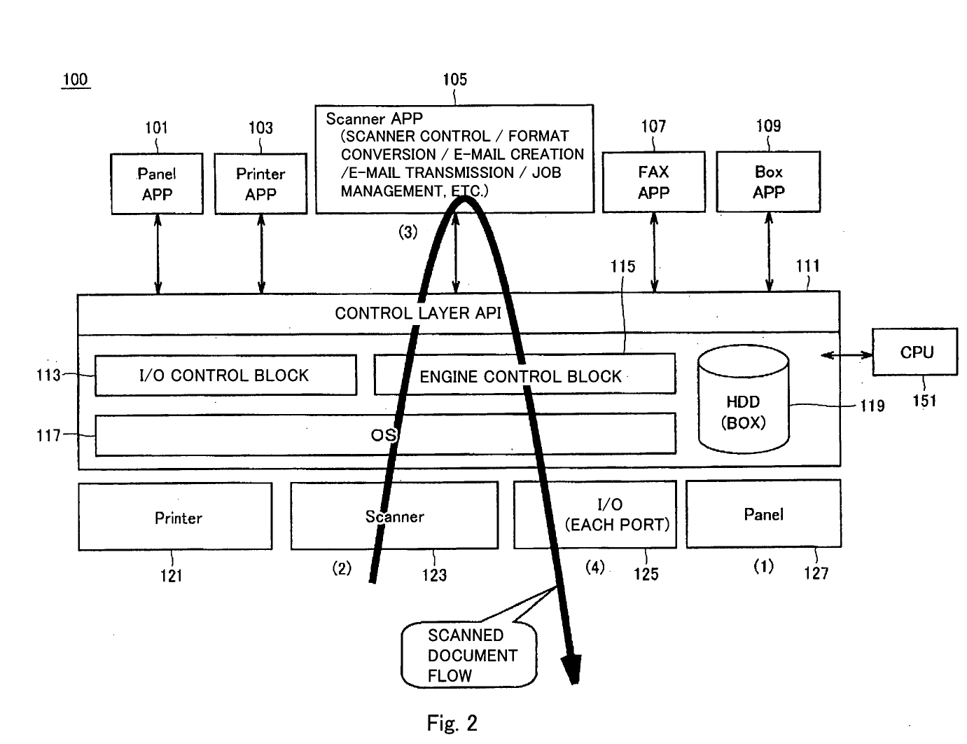

FIG. 2 is a block diagram showing the construction of one of the MFPs 100a, 100b shown in FIG. 1. An MFP is a complex apparatus including a scanner function, copier function, fax function and printer function.

With reference to the drawing, the MFP 100 has a panel application 101 to control the operation panel, a printer application 103 for printer control, a scanner application 105 for scanner control, a CPU 151 that executes these applications and performs various types of processing, a facsimile application 107 for sending and receiving faxes, and a box application 109 to control the box (hard disk drive) that stores image data.

The scanner application 105 is a software program to execute such processes as scanner control, format conversion, e-mail creation, e-mail transmission and job management.

The MFP 100 includes a control layer API (Application Program Interface) 111, an I/O control block 113, an engine control block 115, an OS (Operating System) 117 and a hard disk drive (box) 119.

The MFP 100 also has a printer 121 comprising hardware, a scanner 123 comprising scanning means, an I/O 125 and an operation panel 127.

The operation panel 127 in this embodiment comprises a liquid crystal display device layered with a touch panel. One-touch buttons are displayed on the liquid crystal display device based on one-touch information, and pressing of a one-touch button is detected via the touch panel.

When scanning of an original document is carried out by the scanner 123 (operation (2) in FIG. 2) through the operation of the operation panel 127 (operation (1) in FIG. 2), the scan data is sent to the scanner application 105, which performs format conversion of the scan data as well as e-mail creation and transmission (operation (3) in FIG. 2). The data is subsequently sent to an external apparatus via the I/O 125 (operation (4) in FIG. 2). The arrow in FIG. 2 shows this data flow.

FIG. 3 is a block diagram showing the construction of any of the PCs 300a, 300b and the server 400 shown in FIG. 1. These comprise ordinary personal computers, and in this embodiment have identical constructions.

With reference to the drawing, the PC (or server) includes a CPU 601 that controls the entire apparatus, a display 605, a LAN (Local Area Network) card (or modem card) 607 to enable connection to a network or communication with an external device, an input device 609 comprising a keyboard and mouse or the like, a flexible disk drive 611, a CD-ROM drive 613, a hard disk drive 615, a RAM 617 and a ROM 619.

Program or other data recorded on a flexible disk F can be read by the flexible disk drive 611, and program or other data recorded on a CD-ROM 613a can be read by the CD-ROM drive 613.

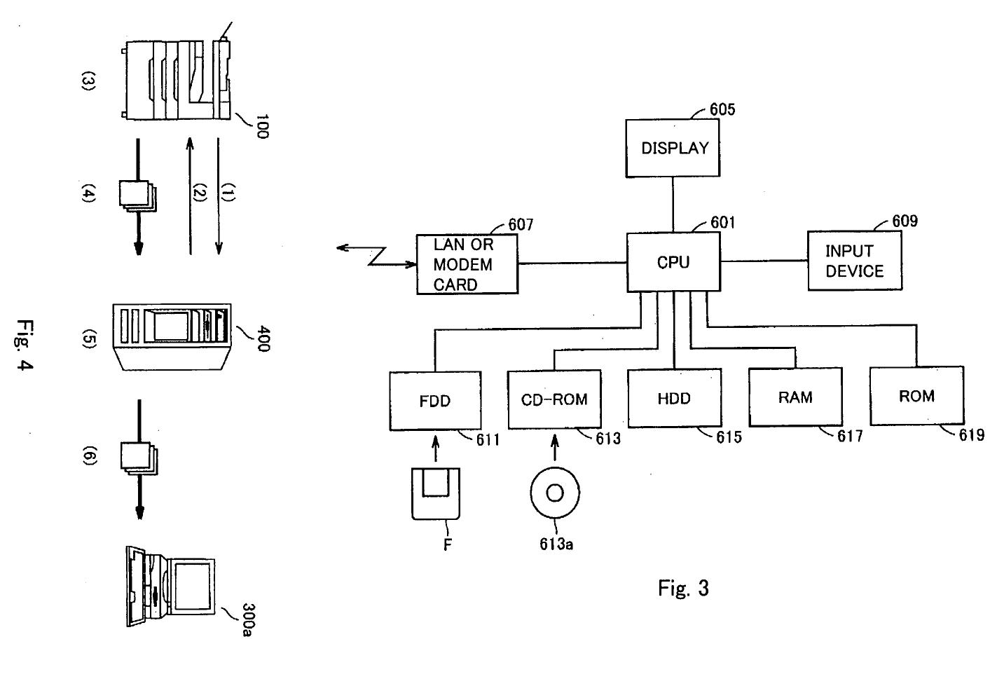

FIG. 4 is a drawing to explain the processing that takes place in the MFP 100, server 400 and PC 300a of this embodiment. This processing is executed by the CPU of each apparatus in accordance with control programs installed respectively in the MFP 100, server 400 and PC 300a (in the case of the MFP 100, the scanner application 105 shown in FIG. 2).

An example in which the user sends image data obtained by scanning using the MFP 100 to the PC 300a via the server 400 will be described herein.

(1) First, the user goes to the location of the MFP 100 and inputs his user account using the MFP operation panel 127. The MFP 100 performs authentication with the server 400 using such user account (operation (1) in FIG. 4). When authentication is successful, a session is established between the MFP 100 and the server 400.

(2) When authentication is successful, the server 400 sends the MFP 100 the public one-touch information (i.e., the one-touch information shared by multiple unspecified users) and the one-touch information for the user himself (operation (2) in FIG. 4).

(3) The MFP 100 creates one-touch buttons based on the one-touch information and displays them on the operation panel 127 (operation (3) in FIG. 4).

(4) When the user begins scanning using the MFP 100 regardless of whether a one-touch button is used, the MFP 100 sends the image data and the setting information therefor (one-touch information) to the server 400 (operation (4) in FIG. 4).

(5) The server 400 registers the received one-touch information as one-touch information for the user for whom a session is underway (operation (5) in FIG. 4).

(6) The server 400 transmits the image data using the specified delivery method (operation (6) in FIG. 4).

The transmission method can be e-mail, FTP or SMB, but in this embodiment, an example of transmission by e-mail will be used. The setting information (one-touch information) that the MFP 100 sends to the server 400 together with the image data comprises image data recipient information and scanning parameter values (scan mode) or transmission parameter values, but it is also acceptable if such setting information comprises only part of such information.

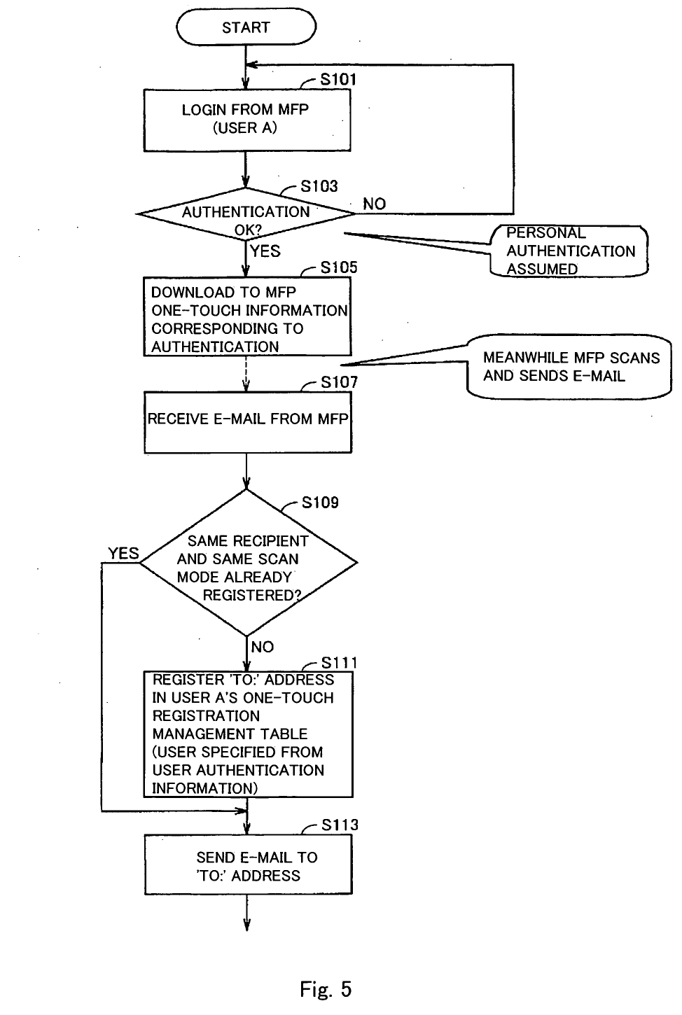

FIG. 5 is a flow chart showing the processing performed by the server 400.

If login (in this example, login by the user A) is received from the MFP in step S101, authentication is carried out in step S103. If authentication is approved, one-touch information for the authenticated user (the user A in this example) and the ‘public’ one-touch information are sent to the MFP in step S105 based on the one-touch registration management table (see FIG. 7) recorded on the hard disk 615.

It is also acceptable if the public one-touch information is not sent or if the user can select whether or not to send the public one-touch information.

The MFP then displays one-touch buttons on the operation panel 127 based on the received one-touch information, receives input therefrom, scans the original document and sends the image thereof.

If an e-mail and one-touch information are received by the server 400 from the MFP in step S107, it is determined in step S109 whether or not the received one-touch information is registered in the one-touch registration management table in connection with the authenticated user.

If the answer in step S109 is NO, the one-touch information is recorded in the one-touch registration management table cell for the authenticated user in step S111. The ‘recipient’ information comprising a one-touch information item can be obtained from the ‘To:’ window of the e-mail.

The data is then sent to the original recipient from the server 400 in step S113.

If the answer in step S109 is YES, because that means that the same information is already registered in the one-touch registration management table, no new registration is carried out, and the MFP advances to step S113 without executing any processing.

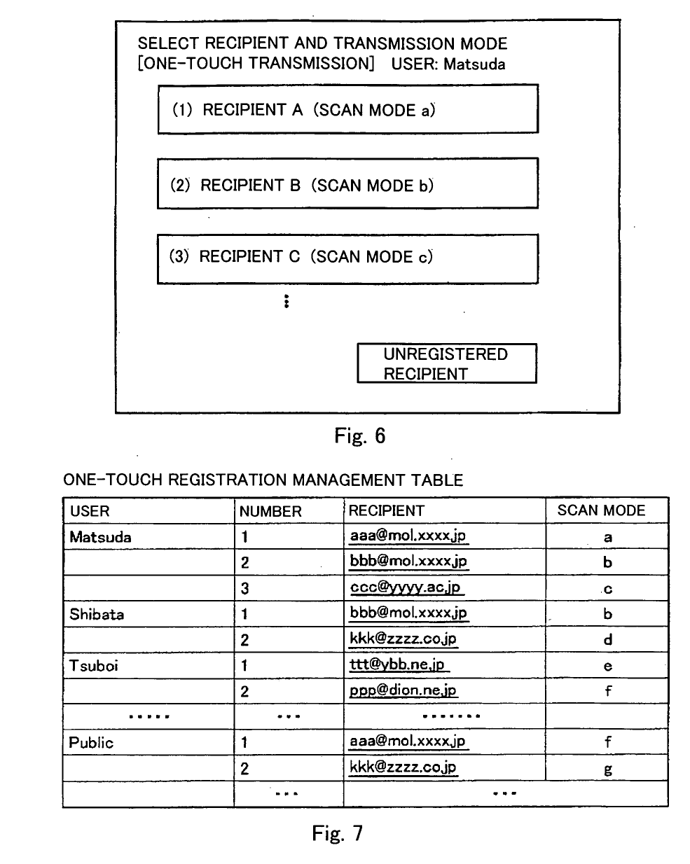

FIG. 6 shows a specific example of one-touch buttons displayed on the operation panel 127 of the MFP.

An example in which one-touch buttons are displayed with the one-touch information comprising recipient and scan parameter value information is described here. The one-touch information for each user is read from the server, and one-touch buttons as shown in FIG. 6 are displayed.

When the user presses a one-touch button, the recipient and parameter values (such as the scan mode or the transmission mode) are automatically set.

When the ‘unregistered recipient’ button in FIG. 6 is pressed, transmission to a recipient using parameter values not registered with a one-touch button can be made. When transmission is made to such an unregistered recipient using unregistered parameter values, this information is stored in the server in association with the user as new one-touch information.

FIG. 7 shows a specific example of the one-touch registration management table.

With reference to the drawing, the one-touch number and the recipient and scan mode information corresponding thereto are recorded for each user (account).

A ‘one-touch number’ is a number that indicates the order of display for the one-touch buttons, and corresponds to (1)-(3) shown in FIG. 6.

In this drawing, one recipient is recorded in association with a single one-touch number, but it is also acceptable if multiple recipients are recorded in association with a single one-touch number. In this case, it is determined in step S109 in FIG. 5 whether or not a registration matching all of the multiple recipients has been carried out.

Where only the recipient information is recorded as one-touch information, the ‘scan mode’ column in FIG. 7 is not needed. In this case, only the recipient information is shown in connection with the one-touch buttons shown in FIG. 6.

Where only the scan mode is recorded as one-touch information, the ‘recipient’ column in FIG. 7 is not needed. In this case, only the scan parameter values are displayed in connection with the one-touch buttons shown in FIG. 6. It is also acceptable if transmission parameter values (transmission mode) are recorded as one-touch information instead of scan parameter values.

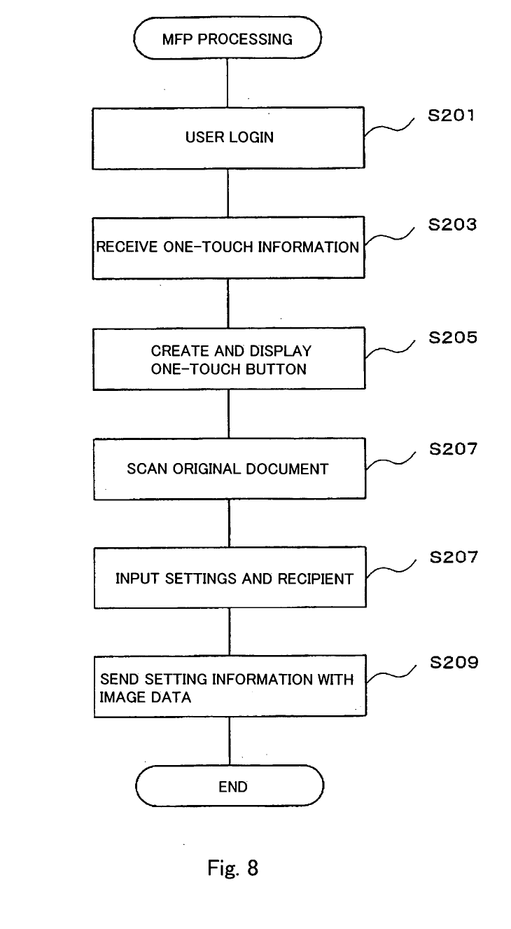

FIG. 8 is a flow chart showing the processing performed by the MFP 100.

With reference to the drawing, when the user executes login in step S201, authentication is carried out by the server 400. In step S203, the one-touch information for the authenticated user and the public one-touch information sent from the server 400 are received.

In step S205, one-touch buttons are created based on the received one-touch information and displayed on the liquid crystal display device. In step S207, scanning of the original document is carried out and in step S208 the one-touch information comprising the recipient information and parameter values is input.

In step S209, the one-touch information comprising the recipient information, etc. is sent to the original recipient together with the image data via the server 400. If such information is not currently registered as one-touch information in the server, it is registered as new one-touch information.

According to this embodiment, the burden on the user can be reduced by having one-touch information used by the user on an MFP or the like automatically registered on the server. In addition, the operability of the operation panel of the MFP or the like is also improved.

### MODIFIED EXAMPLE 1

In the embodiment described above, the user was specified based on the account and one-touch information was recorded, but it is also acceptable if the user is specified based on the ‘From:’ address of the e-mail and one-touch information is recorded in association with the user.

With reference to FIG. 4, the following processing is carried out in this modified example.

(1) When the user inputs the public account from the operation panel 127 of the MFP 100, the MFP 100 performs authentication with the server 400 using the public account (operation (1) in FIG. 4). When the authentication is successful, a session becomes established.

(2) When authentication is successful, the server delivers the public one-touch information (see FIG. 7) to the MFP (operation (2) in FIG. 4).

(3) The MFP 100 creates one-touch buttons based on the one-touch information (operation (3) in FIG. 4).

(4) When the user begins scanning regardless whether or not he uses a one-touch button, the MFP sends one-touch information (comprising recipient information and scanning parameter values, for example) to the server 400 together with the image data (operation (4) in FIG. 4).

(5) The server specifies the user from the ‘From:’ address of the e-mail header, and registers the one-touch information as one-touch information for that use (operation (5) in FIG. 4).

Where the user cannot be specified based on the ‘From:’ address, user specification is carried out based on the history of past recipients and is registered as one-touch information.

(6) The server 400 sends the image data to the original recipient using the specified delivery method (operation (6) in FIG. 4).

### MODIFIED EXAMPLE 2

In the embodiment described above, the user was specified based on the account and one-touch information was recorded, but it is also acceptable if one-touch information is recorded in association with the user without the establishment of a session.

With reference to FIG. 4, the following processing is carried out in this modified example.

(1) The user accesses the server 400 from the MFP 100 panel and requests updating of the one-touch information stored on the MFP. When this occurs, no session is underway (operation (1) in FIG. 4).

(2) The server 400 delivers the registered one-touch information to the MFP 100 (operation (2) in FIG. 4).

(3) The MFP 100 creates one-touch buttons based on the one-touch information (operation (3) in FIG. 4).

(4) When the user begins scanning regardless of whether or not a one-touch button is used, the MFP 100 sends one-touch information (comprising the recipient information and scanning parameter values, for example) to the server 400 together with the image data (operation (4) in FIG. 4).

(5) The server 400 specifies the user from the ‘From:’ address of the e-mail header, and registers the one-touch information as one-touch information for that user (operation (5) in FIG. 4).

Where the user cannot be specified based on the ‘From:’ address, user specification is carried out based on the history of past recipients and is registered as one-touch information.

(6) The server sends the image data using the specified delivery method (operation (6) in FIG. 4).

[Other]

Image data may be sent from the MFP to the server as a file attached to an e-mail or simply by itself.

The one-touch information sent from the MFP to the server may be included in the ‘To:’ address of the e-mail that indicates the recipient or in the main text of the e-mail. It can also comprise attached data or be included in the image data.

A program that executes the processing shown in the flow charts for the above embodiment may be provided, and such program may be provided to the user by recording it on a recording medium such as a CD-ROM, flexible disk, hard disk, ROM, RAM or memory card. Alternatively, the program may be downloaded to an apparatus via a communication circuit such as the Internet.

An MFP was used as an example of the image transmission apparatus in the embodiment described above, but the image transmission apparatus of the present invention may comprise a different type of apparatus. For example, the image transmission apparatus may comprise a scanner having a network function, for example.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

1. An image transmission system comprising an image transmission apparatus and a relay apparatus that sends image data received from said image transmission apparatus to a prescribed recipient, wherein
said relay apparatus including:
a receiving unit for receiving from said image transmission apparatus image data and setting information for transmission thereof;
a specifying unit for specifying a user who sent said image data;
a storage unit for storing and associating said specified user and said setting information;
a transmission unit for sending said received image data to a prescribed recipient in accordance with said setting information; and
an output unit for, when accessed by the user, outputting the setting information stored in the storage unit and corresponding to said user as information for creation of one-touch buttons, and
said image transmission apparatus including:
a transmission unit for sending said image data and said setting information to said relay apparatus;
a receiving unit for receiving said information for creation of one-touch buttons that was output from said relay apparatus; and
a display unit for creating and displaying one-touch buttons based on said information for creation of one-touch buttons.

2. A relay apparatus that sends image data received from an image transmission apparatus to a prescribed recipient, comprising:
a receiving unit for receiving from said image transmission apparatus image data and setting information for transmission thereof;
a specifying unit for specifying a user who sent said image data;
a storage unit for storing and associating said specified user and said setting information;
a transmission unit for sending said received image data to a prescribed recipient in accordance with said setting information; and
an output unit for, when accessed by the user, outputting the setting information stored in the storage unit and corresponding to said user as information for creation of one-touch buttons.

3. The relay apparatus according to claim 2, wherein said setting information is information that indicates the recipient for the image data.

4. The relay apparatus according to claim 2, wherein said setting information includes at least reading parameter values or transmission parameter values for the image data.

5. The relay apparatus according to claim 2, wherein if no setting information is stored for said specified user, said storage unit stores the received setting information in association with said user.

6. The relay apparatus according to claim 2, wherein said receiving unit receives said image data and said setting information by means of an e-mail from said image transmission apparatus.

7. The relay apparatus according to claim 6, wherein said storage unit stores the address of the recipient of said e-mail as said setting information.

8. The relay apparatus according to claim 2, wherein said storage unit stores the setting information shared by multiple users, and said output unit outputs said setting information shared by multiple users together with the setting information for the accessing user.

9. The relay apparatus according to claim 2, wherein said specifying unit specifies said user based on user authentication.

10. The relay apparatus according to claim 2, wherein said specifying unit specifies said user based on the address of the sender of the e-mail.

11. An image transmission apparatus that sends image data to a prescribed recipient via a relay apparatus, comprising:
a first transmission unit for sending to said relay apparatus as information for creation of a one-touch button image data and setting information for transmission thereof;
a second transmission unit for sending to said relay apparatus information to specify the user;
a receiving for receiving information for creation of one-touch buttons for said user that was sent from said relay apparatus in response to the receipt of said information to specify the user; and
a display unit for creating and displaying one-touch buttons based on said information for creation of one-touch buttons.

12. A data processing method executed by a relay apparatus that sends image data received from an image transmission apparatus to a prescribed recipient, comprising the steps of:
receiving from said image transmission apparatus image data and setting information for transmission thereof;
specifying a user who sent said image data;
storing and associating in a prescribed storage device said specified user and said setting information;
sending said received image data to a prescribed recipient in accordance with said setting information; and
outputting the setting information corresponding to said user and stored in said storage device as information for creation of one-touch buttons when accessed by the user.

13. A data processing method executed by an image transmission apparatus that sends image data to a prescribed recipient via a relay apparatus, comprising the steps of:
sending to said relay apparatus image data and setting information for transmission thereof as information for creation of a one-touch button;
sending to said relay apparatus information to specify the user;
receiving information for creation of one-touch buttons for said user that was sent from said relay apparatus in response to the receipt of said information to specify the user; and
creating one-touch buttons based on said information for creation of one-touch buttons and displaying them on a prescribed display device.

14. A computer program product that causes a relay apparatus that sends image data received from an image transmission apparatus to a prescribed recipient to execute a process comprising the steps of:
receiving from said image transmission apparatus image data and setting information for the transmission thereof;
specifying a user who sent said image data;
storing and associating said specified user and said setting information in a prescribed storage device;
sending said received image data to a prescribed recipient in accordance with said setting information; and
outputting the setting information corresponding to said user and stored in said storage device as information for creation of one-touch buttons when accessed by the user.

15. A computer program product that causes an image transmission apparatus that sends image data to a prescribed recipient via a relay apparatus to execute a process comprising the steps of:
sending to said relay apparatus as information for creation of a one-touch button image data and setting information for transmission thereof;
sending to said relay apparatus information to specify the user;
receiving information for creation of one-touch buttons for said user that was sent from said relay apparatus in response to the receipt of said information to specify the user; and
creating one-touch buttons based on said information for creation of one-touch buttons and displaying them on a prescribed display device.
